(19) United States
(12) Patent Application Publication
(10) Pub. No.: US 2017/0360649 A1
(43) Pub. Date: Dec. 21, 2017

(54) POST-SURGICAL OBSTRUCTION TREATMENT RECOVERY AND REHABILITATION THERAPY

(71) Applicant: OTIVIO AS, Oslo (NO)

(72) Inventors: Jonny Hisdal, Oslo (NO); Øyvind Heiberg Sundby, Oslo (NO); Iacob Mathiesen, Oslo (NO)

(21) Appl. No.: 15/629,519

(22) Filed: Jun. 21, 2017

Related U.S. Application Data
(60) Provisional application No. 62/352,860, filed on Jun. 21, 2016.

(51) Int. Cl. A61H 9/00

(52) U.S. Cl. CPC A61H 9/0057; A61H 9/0007; A61H 2205/106; A61H 2201/1642; A61H 2209/00; A61H 2201/1645

(57) ABSTRACT

Medical pressure therapy can be used on a patient having undergone treatment to reopen an arterial obstruction, such as a stenosis or occlusion. The medical pressure therapy can establish and maintain persistently good distal runoff. The can help ensure the patency of the region having undergone the treatment procedure. In some examples, the technique involves enclosing at least a portion of a limb of a patient on which an obstruction treatment procedure has been performed in an enclosure such that the portion of the limb is sealed from external conditions. The technique further involves alternately applying a negative pressure within the enclosure and releasing the negative pressure from within the enclosure, thereby increasing a volume and velocity of blood flowing past a region of the blood vessel previously-obstructed and thereby increasing distal runoff.

### TECHNICAL FIELD

This disclosure relates to systems and techniques for promoting blood flow in a post-stenotic region of an artery to improve or maintain patency, following endovascular or surgical procedures to treat obstructions.

Granted patents U.S. Pat. No. 7,833,179, issued Nov. 16, 2010; U.S. Pat. No. 7,833,180, issued Nov. 16, 2010; U.S. Pat. No. 8,021,314, issued Sep. 20, 2011; U.S. Pat. No. 8,361,001, issued Jan. 29, 2013; U.S. Pat. No. 8,821,422, issued Sep. 2, 2014; and U.S. Pat. No. 8,657,864 issued Feb. 25, 2014 are co-owned with the current application, and the entire contents of each is incorporated herein by reference

### BACKGROUND

Diseased blood vessels are a widespread medical condition. A narrowing, or stenosis may form by local thickening of the vessel walls, or a lesion may form by an accumulation of atherosclerotic plaque on blood vessel walls. A thrombus (blood clot) may also form in a vessel, especially in a region of turbulent flow adjacent a narrowing. A troublesome form of cardiovascular disease results when a blood vessel becomes occluded with atheroma or plaque, referred to as a chronic total occlusion.

Until recently, chronic total occlusions have usually been treated by performing a bypass procedure where autologous veins or synthetic grafts are anastomotically attached to locations on the blood vessel upstream and downstream of the occlusion. While effective, such bypass procedures are traumatic to the patient. More recently, endovascular catheter-based intravascular procedures have been utilized to treat hemodynamic significant stenosis or occlusions, with increasing patency. Catheter-based intravascular procedures include angioplasty, atherectomy, stenting, and the like, and are often preferred because they are much less traumatic to the patient. In either case, following surgical treatment, the post-stenotic region is left in a delicate state and the patient is often subjected to activity limits or restrictions for a number of weeks or months to prevent injury or collapse of the post-stenotic region.

Restenosis, or a reoccurrence of narrowing, is a common adverse event of endovascular procedures and may be exacerbated by the required inactivity of the patient. Restenosis may be triggered by clotting due to damage caused to the artery walls during endovascular procedures or by the body's immune response to the insertion of a stent. Resulting poor distal blood flow may also lead to redepositing of plaque and occlusion of the treated area, or promote thrombosis formation within a graft. It is essential that the risk of restenosis be addressed as soon as possible after endovascular procedures.

To address the risk of restenosis, it is common to administer pharmaceutical treatments intended to inhibit clotting and tissue growth immediately following endovascular procedures, potentially for the remainder of the patient's life. Such pharmaceutical treatments are not always successful, can be expensive, and often risk uncomfortable or dangerous side effects for the patient.

Alternative means for preventing restenosis have failed to emerge from the prior art, particularly due to the sensitivity of the post-stenotic region to patient activity and mechanical stimulus in the period immediately following surgery.

There exists a need for an improved method of post-surgical obstruction treatment recovery that inhibits restenosis and promotes patency without the drawbacks of prior art methods. On these premises the disclosure is based on the object of providing an improved and safe method of post-surgical obstruction treatment recovery based on non-pharmaceutical promotion of blood flow through or around the post-stenotic region following surgical treatment.

### SUMMARY

This disclosure is directed to systems and methods for enhancing distal runoff, or blood flow through a previously obstructed region of a blood vessel, following an interventional surgical procedure to treat the obstruction. The obstruction can be caused by one or more stenosis and/or occlusions. In different applications, the surgical procedure performed may involve inserting a graft bypassing an obstructed region of the blood vessel, inserting an expandable stent or inflatable balloon into the obstruction to force open the obstructed region of the blood vessel, or inserting an atherectomy device to cut the obstruction out of the blood vessel. In any application, the surgical procedure performed can allow blood to flow past the obstructed regions of the blood vessel, e.g., by allowing blood to flow through the graft and around the obstruction, bypassing the obstruction, or through the reopened blood vessel. Because of the surgical procedure, blood can flow around and/or through the previously obstructed region of the blood vessel, and into or from a distal region of the limb previously containing the obstruction.

To promote and enhance distal runoff following a treatment procedure, medical pressure therapy may be applied according to systems and methods of the present disclosure. According to a method of the present disclosure, a distal portion of the patient's limb on which a procedure has been performed to treat an obstruction may be enclosed within a therapeutic pressure device comprising at least a pressure chamber, pressure control unit, limb support structure, and a seal, in order to seal the portion of the limb from the ambient pressure environment. Thereafter, non-atmospheric pressure of varying magnitude may be generated within the enclosed environment of the pressure chamber and the seal containing the portion of the limb by the pressure control unit of the therapeutic pressure device. In the case of a femoral artery blockage, a catheter may be inserted into the leg of the patient to reopen the blockage (e.g., obstruction) and/or a vascular graft attached bypassing the blockage within the leg of the patient. The patient may subsequently undergo pressure therapy by positioning the foot of their leg previously containing the blockage in an enclosed pressure chamber of the therapeutic pressure device, e.g., such that a portion of the leg distal of the location of the blockage is contained within the chamber. Negative pressure therapy can thereafter be applied to the portion of the limb within the pressure chamber of the therapeutic pressure device to promote distal runoff.

Although previously believed to potentially be damaging to a post-surgical stenotic region, medical pressure therapy using a therapeutic pressure device has been shown to not only provide improved distal runoff without the adverse side-effects of pharmaceutical treatments, but also without risking damage to the post-stenotic region as associated with other post-surgical activities, e.g. exercise. Further, medical pressure therapy by the therapeutic pressure device provides the advantage of a highly controllable method for increasing runoff. Meaning a clinician or patient can selectively increase or decrease blood flow by controlling the pressure generated by the pressure control unit within the pressure chamber while monitoring blood flow through a post-stenotic region with a blood flow monitoring device in real-time.

It is believed that the reason for the advantages of using negative pressure with the therapeutic pressure device rather than positive pressure in improving distal runoff without causing harm to the post-stenotic region is due to the differences between the dilation and constriction mechanisms associated with negative and positive pressures, respectively.

Positive pressure pulses generated by prior art positive pressure devices may constrict arteries, arterioles, arteriovenous anastomoses and/or capillaries in the portion of body subjected to the positive pressure pulses to force blood through the body, potentially creating constricting stress on the post-stenotic region both inside the body and on the exterior of the body. During application of non-atmospheric negative pressure pulses using the therapeutic pressure device of the current disclosure (e.g., generating negative pressure pulses and releasing the pulses), arteries, arterioles, arteriovenous anastomoses and/or capillaries in the portion of body subjected to the negative pressure pulses may dilate, thereby increasing blood flow. Without wishing to be bound by any particular theory, it is believed that veins and venules may also dilate, with dilatation of veins and venules being greater on the venous side than on the arterial side due to a lesser developed (thinner) muscular vessel wall. The greater dilatation on the venous side may create an increased arterio-venous pressure gradient over the capillaries (and the arteriovenous anastomoses if they are open). This may contribute to greater blood flow without applying a potentially damaging constricting force.

When the non-atmospheric pressure pulses are applied to a limb having recently undergone a procedure to treat an obstruction, medical pressure therapy by the therapeutic pressure device can increase distal runoff (e.g., amount and/or velocity of blood flow) as compared to if the limb was not treated with pressure therapy following obstruction treatment. This can help ensure the patency of the region of the blood vessel having undergone treatment, prevent restenosis, and increase the long-term efficacy of the obstruction treatment procedure without the drawbacks of prior art methods.

In one example, a method is described that includes enclosing at least a portion of a limb of a patient treated for an arterial obstruction within the pressure chamber of the therapeutic pressure device. The example specifies that the treatment procedure for the arterial obstruction involves bypassing or reopening the arterial obstruction. The method further involves alternately applying a negative pressure within the enclosure and releasing the negative pressure from within the enclosure, increasing a volume and velocity of blood flowing past a region of the artery previously obstructed and increasing distal runoff.

In another example, a method is described that includes performing a medical procedure on a patient having an obstruction within a vascular structure of a limb. The medical procedure includes either opening the obstruction or bypassing the obstruction. The method further involves, subsequent to performing the medical procedure, introducing at least a portion of the limb into a pressure chamber of a therapeutic pressure device such that the portion of the limb is sealed from external conditions. The method also includes alternatingly generating negative pressure pulses within the pressure chamber by the pressure control unit and releasing negative pressure from the pressure chamber by the pressure control unit.

The method may also include the use of a safety opening on the pressure chamber, whereby the negative pressure pulses are prevented from becoming too high or holding for too long which might damage the post-stenotic region or the limb of the patient.

A support structure may be placed on the limb of the patient in order to hold the limb in a fixed position within the pressure chamber. The support structure is configured to support the limb and protect the post-stenotic region by including an opening in the support structure to avoid applying direct pressure to the post-stenotic region.

In a variation of the method the distal runoff of a patient may be directly monitored in real-time, to ensure the selection of a pressure level and treatment duration.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a flow diagram showing an example technique involving pressure therapy treatment according to the disclosure.

FIGS. 2A and 2B are schematic illustrations of different example bypass procedures that may be performed on a patient to treat an occlusion.

FIG. 3 is a schematic image showing different example techniques for treating an occlusion.

FIG. 4 is a perspective view on therapeutic pressure device for delivering medical pressure therapy to a patient.

FIG. 5 is an image showing blood flow through a stent during pressure pulses with corresponding EKG readings for an example patient.

FIG. 6 is perspective view of a limb support structure for supporting the limb of a patient inside the system of FIG. 4.

FIG. 7 is a front perspective view of the limb support structure according to FIG. 6.

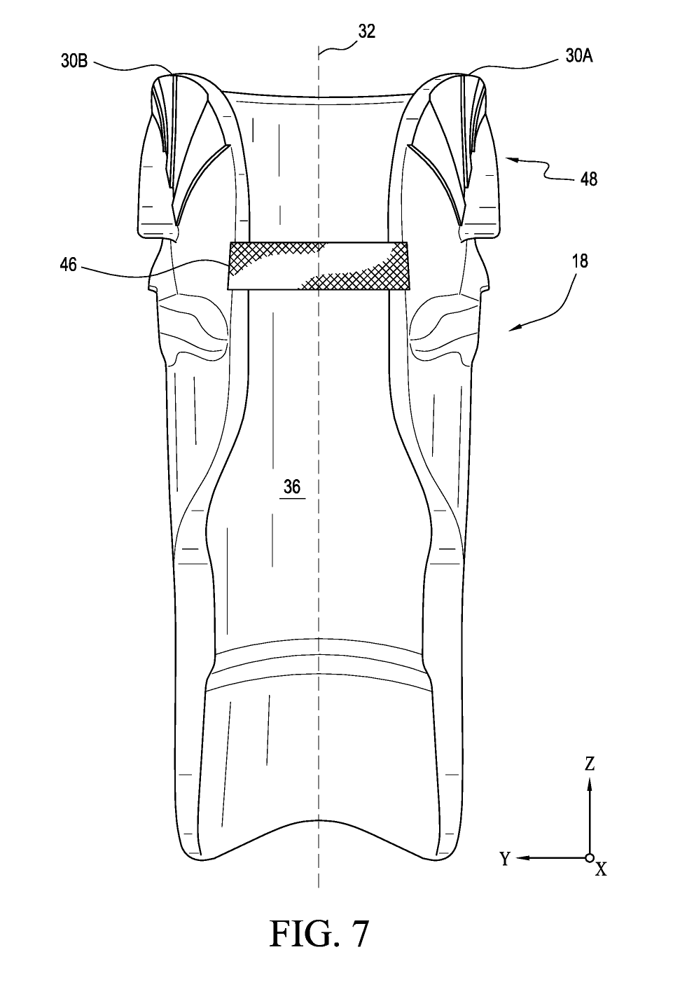

### DETAILED DESCRIPTION

This disclosure relates to systems and techniques for post-operative treatment of a patient having undergone a medical procedure to treat a partially or fully blocked blood vessel. In some examples, a technique involves inserting a portion of a limb of the patient on which the medial procedure was performed into a pressure chamber, substantially pressure isolating the portion of the limb from the ambient environment. Alternating pressure pulses can then be applied to the portion of the limb within the pressure chamber by alternatingly generating and releasing negative pressure in the pressure chamber. The alternating pressure pulses can increase the volume and/or velocity of blood flowing past the previously-blocked region of the blood vessel on which the medical procedure was performed, increasing the volume and/or velocity of blood flowing distally (away from the center of the body toward the extremity) of the location of the blockage (e.g., before treatment).

In practice, it is an advantage of the current method that the patient may undergo medical pressure therapy shortly after a medical procedure treating the obstruction is performed, for example, such that the first pressure therapy treatment occurs from a few minutes to few weeks after the medical procedure, preferably the first pressure therapy treatment occurs as early as possible within a predetermined time period ranging from 10 minutes after the medical procedure to 2 weeks after the medical procedure, or 1 day after the medical procedure to 10 days after the medical procedure, particularly during the period of time that the patient is restricted from activity.

While the patient may undergo only a single session of medical therapy, the patient may more typically undergo multiple sessions of the pressure therapy to promote and maintain good distal runoff during the post-operative healing process. The patient may undergo daily predetermined treatment sessions, or one session from every one to three days, for a period ranging from one week to three months, such as a period ranging from two to eight weeks. Each predetermined treatment session may range from a short period of time, such as 10 minutes or 30 minutes, to a longer period of time, such as 4 hours in some cases. Preferably, each session may involve delivering pressure therapy for a period ranging from 10 minutes to 2 hours, as a session of less than 10 minutes fails to generate lasting impact on the blood flow through the post-stenotic region and a session of more than 2 hours risks adverse side effects of pooling in the limb or damage to the post-stenotic region. The pressure therapy may be part of a more comprehensive post-operative treatment regime and/or evaluation process to help ensure the patient successfully recovers from the medical procedure, patency is maintained within the previously obstructed blood vessel following the medical procedure, and the entire procedure is clinically efficacious.

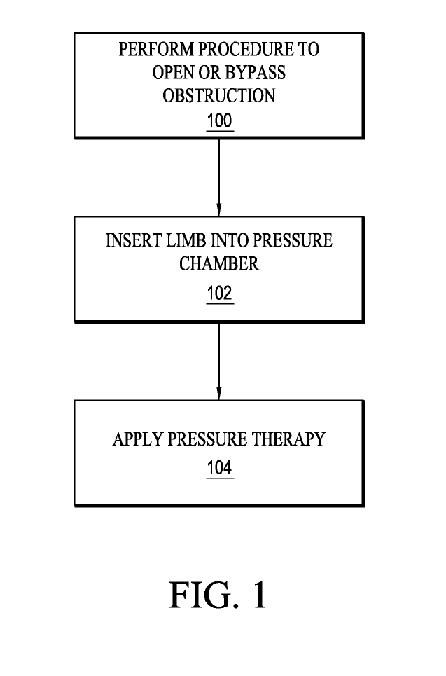

FIG. 1 is a flow diagram showing an example technique involving pressure therapy treatment according to the disclosure. The example technique involves performing a medical procedure on a patient having an obstruction 100. The obstruction may be any partial or full blockage or closing of a blood vessel within the patient, such as a stenosis or occlusion. Example obstructions include emboli, thrombi, calcified lesions, atheroma, macrophages, lipoproteins, and other accumulated vascular materials, or stenosis. Such obstruction s can be caused by many conditions, such as peripheral artery disease. Independent of the location or nature of the occlusion, a medical procedure may be performed on the patient to restore blood flow past the occlusion, as described in greater detail below.

The technique of FIG. 1 involves, after performing the medical procedure on the patient to treat the obstructed region of the blood vessel, inserting the limb of the patient on which the obstruction treatment procedure was performed into a pressure chamber 102. For example, a distal-most region (e.g., foot, hand) of the patient's limb may be entirely enclosed within the pressure chamber 102 such that a proximal portion of the limb extends out through an opening in the pressure chamber. Thereafter, pressure pulses of alternating magnitude can be generated within the pressure chamber by the pressure control unit to deliver pressure therapy to the patient's limb 104. The pressure therapy delivered to the portion of the patient's limb enclosed within the pressure chamber can increase the volume and/or velocity of blood flowing through the previously obstructed region of the patient's blood vessel (e.g., the region of the blood vessel on which the obstruction treatment procedure was performed). This can increase distal runoff, helping to prevent thrombosis formation, plaque deposition, or other reocclusion within the treated region of the blood vessel, while also increasing patency.

While the different steps of the technique of FIG. 1 are illustrated and described as being performed sequentially, different individuals may perform different steps or portions of the technique. For example, a surgeon may perform the procedure to treat the obstructed blood vessel 100. During post-operative recovery, a different post-operative clinician either at the same facility as the treating surgeon or a different facility may provide the pressure therapy treatment on the limb of the patient on which the medical procedure to treat the obstructed blood vessel was performed 102, 104. In some applications, an in-home treatment system may be provided, allowing the patient to provide the pressure therapy treatment themselves. Thus, different individuals working in combination may perform different aspects of the disclosed techniques, and the disclosure is not limited in this respect.

With further reference to FIG. 1, the example technique involves performing a medical procedure on a patient having an obstruction to restore blood flow past the obstruction 100. The obstruction may be within any blood vessel of the patient. A blood vessel is an elastic tubular channel, such as an artery, a vein, or a capillary, through which blood circulates. Arteries transport oxygenated blood away from the heart. Veins transport de-oxygenated blood towards the heart.

An obstruction may form within a blood vessel of a patient for many reasons. One common cause of an obstruction is peripheral vascular disease (“PVD”), such as peripheral arterial disease (“PAD”). Peripheral vascular disease is the progressive narrowing of the arterial tree by the atherosclerotic process which results in diminished blood flow to vital organs and extremities beyond the site of narrowing or occlusion. The most common cause is the buildup of plaque on the inside of arteries. Plaque is made of extra cholesterol, calcium, and other material in the blood. Over time, plaque builds up in the walls of the arteries, including those that supply blood to the legs. High cholesterol, high blood pressure, and smoking all contribute to plaque buildup. Diabetes is another factor in disease progression.

Independent of the cause, an obstruction may form within the vascular system of the patient, which is the system made up of all vessels that carry blood and lymph through the body. An obstruction may totally block flow through a blood vessel (e.g., such that no blood flows through the vessel) or may only partially block blood flow (e.g., such there is a passageway or lumen through which some blood may flow). Obstructions requiring treatment often form within extremities, such as a leg (including foot) or arm (including hand). With PAD, occlusions are more common in the leg, with frequent locations including the iliac artery, the femoral artery, the popliteal artery, and the tibial artery. An obstruction may form in an artery downstream (toward blood flow) of the profunda femoris,

Surgical intervention may be used to treat the obstruction and restore blood through the obstruction region of the blood vessel 100. One procedure that can reopen the blood vessel in the region containing the obstruction is balloon angioplasty in which an inflatable balloon is introduced within the stenosed region of the blood vessel to dilate the obstructed vessel. The balloon catheter can be inserted into the patient's arterial system and advanced and manipulated into the area of stenosis in the artery. The balloon is then inflated to compress the stenosis (e.g., plaque) and press the vessel wall radially outward to increase the diameter of the blood vessel.

Another procedure that can reopen the blood vessel in the region containing the obstruction is laser angioplasty, which utilizes a laser to ablate the stenosis by super heating and vaporizing the deposited stenosis (e.g., plaque). Atherectomy is yet another method of treating a stenosed blood vessel in which a cutting blade is rotated to shave the stenosis from the arterial wall. A vacuum catheter may capture the shaved stenosis (e.g., plaque or thrombus) from the blood stream during this procedure.

Another example of a procedure that can reopen the blood vessel, a stenosis can be treated by placing a stent into the stenosed region to hold open and sometimes expand the segment of the blood vessel or other arterial lumen. Stents may be useful in the treatment or repair of blood vessels after a stenosis has been compressed by percutaneous transluminal coronary angioplasty (PTCA), percutaneous transluminal angioplasty (PTA) or removal by atherectomy or other means. Stents are usually delivered in a compressed condition to the target site through a catheter, and then are deployed at the target location into an expanded condition to support the vessel and help maintain it in an open position.

Stents typically have fallen into two general categories of construction. The first stent is expandable upon application of a controlled force, often through the inflation of the balloon portion of a dilatation catheter which, upon inflation of the balloon or other expansion means, expands the compressed stent to a larger diameter to be left in place within the artery at the target site. The second stent is a self-expanding stent formed from shape memory metals or super-elastic nickel-titanium (NiTi) alloys, which will automatically expand from a compressed state when the stent is advanced out of the distal end of the delivery catheter into the body lumen. Such stents manufactured from self-expandable materials allow for phase transformations of the material to occur, contributing to the expansion and contraction of the stent.

In lieu of reopening the stenotic region of the blood vessel, an alternative procedure that may be performed is a bypass procedure. During a bypass procedure, an autologous or synthetic blood vessel can be anastomotically attached to locations on the blood vessel upstream and downstream of the obstruction. The bypass blood vessel, or graft, can be sutured to the obstructed blood vessel upstream and downstream of the obstruction, providing an alternative fluid pathway, or bypass, around the obstructed region of the blood vessel being treated.

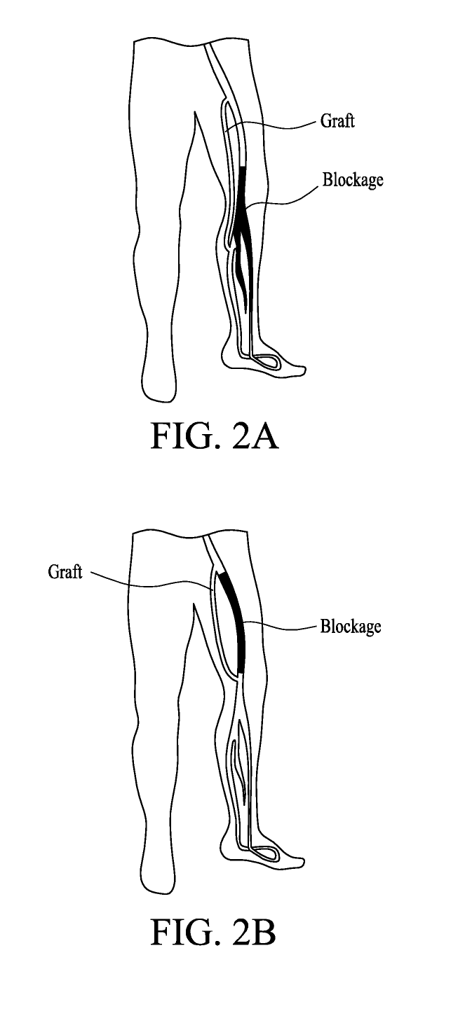

FIGS. 2A and 2B are schematic illustrations of different example bypass procedures that may be performed on a patient to treat an obstruction. FIG. 2A illustrates a patient having an obstruction, or blockage at or below their knee. To bypass the obstruction, a graft is attached from an upstream location above the knee and the obstruction and to a downstream location below the knee and the obstruction. The graft may be attached on the upstream side to the femoral artery and on the downstream side to the tibial artery. FIG. 2B illustrates a patient having an obstruction, or blockage above their knee. To bypass the obstruction, a graft is attached from an upstream location above the knee and the obstruction and to a downstream location, also above the knee and the obstruction. The graft may be attached on the upstream side to the femoral artery and on the downstream side to the popliteal artery.

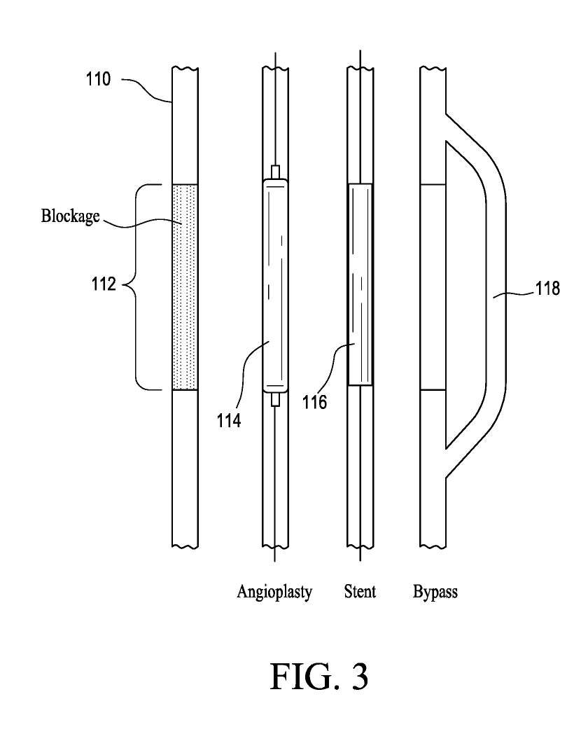

While an obstruction bypass is one example technique for treating an obstruction, other techniques can treat the obstruction. FIG. 3 is a schematic image showing different example techniques for treating an obstruction. As shown in the example, a blood vessel 110 may have an obstructed region 112, which may be partially or fully blocked. An angioplasty balloon 114 and/or stent 116 may be inserted into and through the obstructed region 112 to reopen the obstructed region, transforming the region from an obstructed region to a previously obstructed region. A graft 118 may bypass the obstructed region, again transforming the obstructed region into a previously-obstructed region (even though the obstruction may still be present in the vessel being treated).

With further reference to FIG. 1, the example technique 104 includes inserting the limb on which the obstruction treatment procedure was performed into a pressure chamber. After surgical intervention to treat the obstruction, the access site into the patient can be closed (e.g., via sutures or staples) and the patient given a period of time for post-operative recuperation before beginning medical pressure therapy.

To perform medical pressure therapy, at least a portion of the limb on which the obstruction treatment procedure was performed can be inserted into a pressure chamber and substantially pressure isolated from the ambient pressure environment. The portion of the limb inserted into the pressure chamber may include a portion distal (downstream) of the location of the obstruction for which the medical procedure was performed. Where the obstruction is in a leg or an arm, at least the foot or hand, respectively, on the limb previously containing the obstruction may be inserted into a pressure chamber.

In some applications, the pressure chamber is inserted over and along the length of the limb such that the pressure chamber encloses a portion of the limb containing the obstruction (e.g., along the length of the limb). In other applications, the pressure chamber is inserted over and along the length of the limb such that pressure chamber is positioned distal of, and does not enclose, the portion of the limb containing the obstruction. Where the obstruction is in the leg above the knee, the pressure chamber may enclose the foot of the leg containing the obstruction (e.g., containing before treatment) and extend upward along the length of the leg to a position below where the obstruction was located (e.g., a position below the knee). The pressure chamber may enclose the foot and a length of the leg ranging to a position between the ankle and the knee.

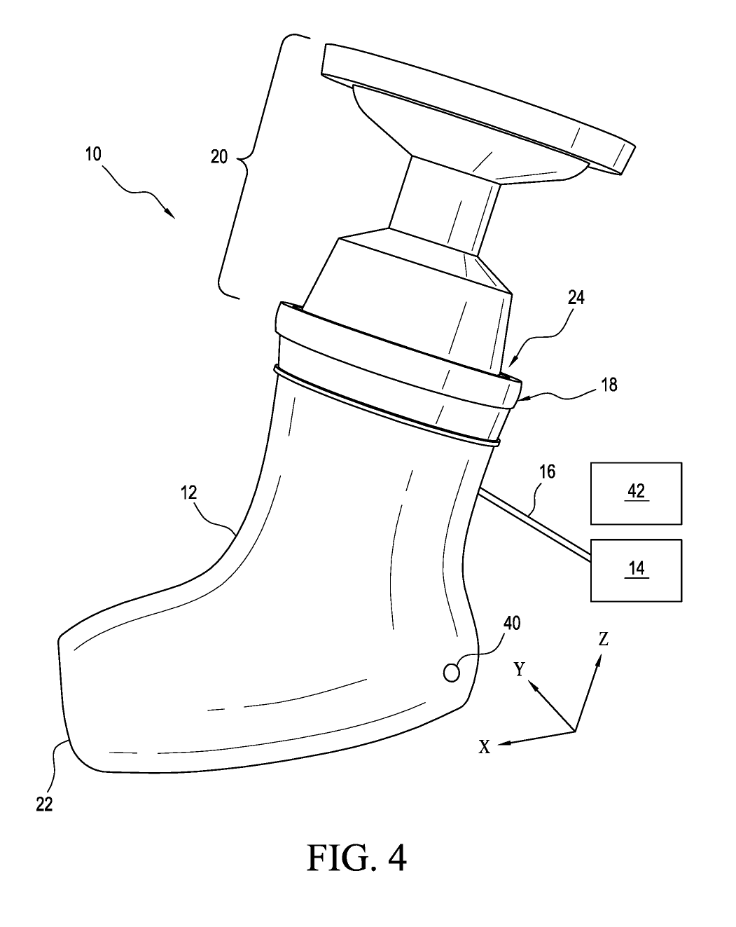

After suitably positioning the portion of the limb in the pressure chamber 102, the technique of FIG. 1 further involves applying pressure therapy to the limb using a pressure control unit of the therapeutic pressure device 104. Pressure therapy may involve alternatingly generating and releasing pulses of negative pressure inside of the pressure chamber. The pulsating pressure therapy can drive blood flow through the limb partially enclosed by the pressure chamber, increasing the volume and velocity of blood flowing past (distally) of the site on which the occlusion treatment was performed. The increased distal runoff caused by pressure therapy can improve the efficacy of the procedure. Additional details on example pressure chamber characteristics and pressure therapy parameters are described regarding FIG. 4.

While any suitable medical pressure therapy system and pressure chamber configuration can provide treatment to a patient according to the disclosure, one example configuration is illustrated in FIG. 4. FIG. 4 illustrates a perspective view of an example system 10 for delivering medical pressure therapy to a patient. System 10 includes a pressure chamber 12 and a pressure control unit 14. The pressure control unit 14 is in fluid communication with an interior of pressure chamber 12 via tubing 16 that provides gas communication between the pressure chamber and the pressure control unit. In the illustrated configuration, system 10 also includes a limb support structure 18 positioned inside of the pressure chamber 12 and a seal 20 that seals an open end of the pressure chamber.

In use, a portion of a patient's body can be inserted into the pressure chamber 12, and more particularly the limb support structure 18 located inside of pressure chamber 12, and the pressure chamber closed to at least partially, and in some examples fully, enclose the body portion. Pressure chamber 12 defines an interior chamber that is pressure isolated from an ambient pressure surrounding the pressure chamber. Seal 20 seals the pressure chamber from gas communication with the ambient environment about the limb of the patient. Pressure control unit 14 can control the pressure in the interior of pressure chamber 12 via tubing 16, thereby controlling delivery of pressure therapy via the pressure chamber.

The pressure chamber 12 in FIG. 4 is illustrated as having a closed distal end 22 and an open proximal end 24 at an opposite end of the closed distal end. Limb support structure 18 and seal 20 extend outwardly from open proximal end 24 of pressure chamber 12 and provide an opening through which a limb of the patient is inserted in the pressure chamber 12. In use, a patient can insert their limb into pressure chamber 12 from the open proximal end 24 to the closed distal end 22. Once inserted into pressure chamber 12, a distal-most portion of the patient's limb can be positioned at or adjacent the closed distal end 22 of pressure chamber 12 with a proximal portion of the limb extending out of the pressure chamber through the open proximal end 24, in the configuration of FIG. 4, a portion of the limb of the patient will extend out through an opening in limb support structure 18 and seal 20 at the open proximal end 24 of pressure chamber 12.

In different configurations, the limb support structure is insertable into and removable from the pressure chamber or permanently retained within the pressure chamber. In either configuration, the limb support structure may wrap at least partially around the perimeter of a patient's limb and fill the empty space that would otherwise exist between the patient's limb and wall(s) of the pressure chamber. In configurations where the limb support structure is insertable into and removable from the pressure chamber, the limb support structure may be inserted into and secured to the pressure chamber in a single fixed location or configured to be securable in a variety of different positions, in order to hold the limb in different orientations.

The limb support structure may perform many functions. The limb support structure may help prevent or minimize the extent to which a patient's limb is sucked into the pressure chamber during negative pressure therapy. As another example, the limb support structure may help distribute pressure substantially uniformly about the perimeter of the patient's limb, helping to avoid contact and pressure on the post-stenotic region, or the formation of pressure marks that may otherwise be created on the patient's limb. Additionally or the support structure may help offset the patient's limb from a closed end of the pressure chamber, increasing the area of the patient's limb exposed to pressure therapy and helping to avoid pressure damage to fragile skin.

Pressure chamber 12 is configured to provide a bounded chamber that is pressure isolated from an exterior or ambient environment. In FIG. 4, pressure chamber 12 is illustrated as having a boot shape configured to receive a foot, an ankle, and a portion of a calf of a patient. Pressure chamber 12 may receive any desired body part(s) (e.g., arm, leg, foot, hand, or combination thereof). Pressure chamber 12 may be sized and/or shaped so an interior of the pressure chamber includes a comparatively wider or larger region and also a comparatively narrower or smaller region. The wider or larger region may be configured to accommodate a larger anatomical feature, such as a hand or foot. The narrower or smaller region may be configured to accommodate a smaller anatomical feature, such as a wrist or ankle. Pressure chamber 12 may be a non-anatomically-specific-shaped structure (e.g., a cylinder, rectangle) that is not specifically shaped to receive a particular limb or anatomical feature of a patient.

Pressure chamber 12 can be fabricated from a variety of materials that allow generation of a non-atmospheric pressure (e.g., negative pressure and/or positive pressure) inside of the chamber. In some configurations, pressure chamber 12 is formed from a rigid material such that the size and/or shape of the pressure chamber does not change. In other configurations, pressure chamber 12 is formed of a flexible material configured to be built around a patient's body part by wrapping, folding, bending or otherwise enclosing the body part in the chamber. For example, a patient may place a limb on a generally flat sheet of material that is subsequently wrapped, folded, or bent about the limb to define the pressure chamber.

Opposing ends of the material may then be joined (e.g., overlapped) and, in some examples, fastened with a mechanical fixation element (e.g., adhesive, snaps, zipper, hook and loop fastener, zipper, or the like). By fabricating the pressure chamber 12 about limb support structure 18, the bulkiness of the pressure chamber and the volume of the pressure chamber may be reduced as compared to rigid pressure systems with fixed volume. Smaller pressure chamber volumes (e.g., air volumes) may reduce the need for larger pumps or systems generating the non-atmospheric pressure.

Although not shown in the example of FIG. 4, pressure chamber 12 may have a joint to facilitate insertion and removal of a body part of a patient into and out of pressure chamber 12. The joint may extend along the length of pressure chamber 12 and provide ready access to an interior of the pressure chamber. The joint may be a location at which opposing portions of pressure chamber 12 join when the pressure chamber is closed and also separate apart to open the pressure chamber. Pressure chamber 12 may fold open from a tubular structure in a closed configuration to a planar structure in an open configuration.

In some applications, system 10 is portable such that the system can be carried by one human individual from one location to another location. Rather than requiring system 10 to be used in a fixed, controlled environment such as in a medical clinic, the system in these examples can be used in the field to deliver acute, time-sensitive treatment. System 10 may be used in military applications, acute medicine, disasters, or any other situation where portability and transportability are desired. The components of system 10 may be fitted in a bag or a transport medium in these configurations, which can be carried by a soldier or a rescue person. In some such configurations, a portable power supply (e.g., battery) may be included to power pressure control unit 14. While system 10 may be configured as a portable system, other configurations of the system are intended for a fixed, controlled environment. It should be appreciated that the disclosure is not limited in this respect. Additional details on example configurations of pressure chamber 12 that can be used in system 10 are described in International Patent Application Nos. PCT/IB2016/000646 and PCT/IB2016/000706, the entire contents of both of which are incorporated by reference.

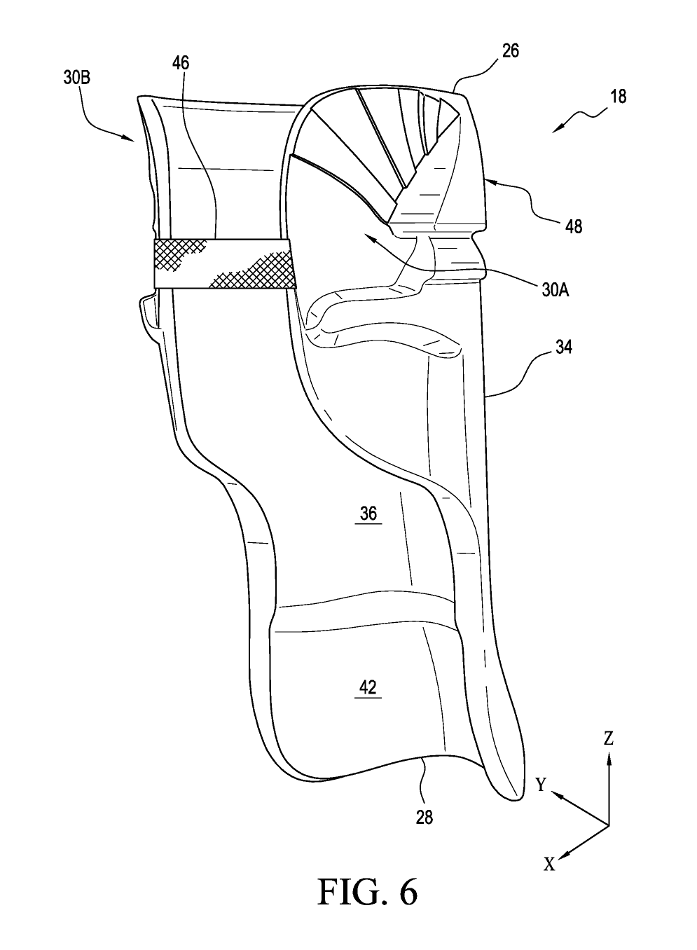

As shown in FIG. 6, limb support structure 18 has an elongated body that extends from a proximal end 26 to a distal end 28. Once positioned inside of pressure chamber 12, the distal end 28 of the elongated body is positioned towards the closed distal end 22 of the pressure chamber 12. Depending on the configuration of pressure chamber 12, the proximal end 26 of limb support structure 18 may be positioned entirely within pressure chamber 12, such than an uppermost region 48 of the limb support structure is below an uppermost edge of the pressure chamber, or an uppermost region 48 of the limb support structure may project above an uppermost edge of the pressure chamber to provide increased support to an upper portion of the limb and protect the limb from the uppermost edge of the pressure chamber.

In the illustrated configuration of FIG. 6, limb support structure 18 is formed of a sheet of material contoured to conform to the shape of a circular limb. The limb support structure 18 has a pair of wings 30A and 30B (collectively “wings 30”) that are configured to extend at least partially, and in some examples fully, around the limb position inside of pressure chamber 12. Wings 30 can extend outwardly from a longitudinal centerline 32 that bisects limb support structure 18 in opposed directions. Wings 30 may be flaps or other structures that are sufficiently conformable to wrap at least partially around the limb of the patient inserted into pressure chamber 12.

In use, a rearwardly facing wall surface 34 of limb support structure 18 can be positioned adjacent to and, in some examples in contact with, a rearward wall surface of pressure chamber 12. A frontwardly facing wall surface 36 that is opposite the rearwardly facing wall surface 34 can be in contact with the limb of the patient inserted into pressure chamber 12. For example a user may insert their limb leg, into limb support structure 18 such that their calf is in contact with outwardly facing wall surface 36. Wings 30 can wrap in opposed directions at least partially and, depending on the size of the limb of the patient undergoing treatment, fully around the circumference of the leg of the patient. In other configurations, limb support structure 18 may not have wings 30 but may instead form a continuous perimeter (e.g., circumference) of material that defines a lumen through which a patient inserts their limb or may include an extension piece 46 for securing around a limb.

In some advantageous applications, limb support structure 18 is configured to minimize the pressure applied to those portions of the limb on which an obstruction treatment procedure was performed. Limb support structure 18 may have a second region 42, including a groove, pocket, cutout, or other region devoid of material, which is configured to be positioned adjacent to the region of the limb on which the obstruction treatment was performed. Instead of configuring the limb support structure to contact and press against the skin overlying the artery on which the obstruction treatment procedure was performed, the limb support structure may contact areas of the limb adjacent the artery.

The wings 30 of the limb support structure may be positioned to contact areas adjacent the limb of the artery while not contacting the skin overlying the artery on which the obstruction treatment procedure was performed. Pressure applied by limb support structure 18 to the skin of the patient may not press against the outside of the limb over the artery on which the obstruction treatment procedure was performed. Rather, such regions of the limb may be offset from limb support structure 18 by a pocket formed in the limb support structure, with the limb support structure contacting adjacent (e.g., upper and lower) regions of the limb. In other configurations, limb support structure 18 includes no offset or pocket over the region of the limb containing the artery on which the obstruction treatment procedure was performed but instead contacts the limb over such region.

System 10 in FIG. 4 also includes pressure control unit 14. Pressure control unit 14 may include a positive pressure pump, vacuum pump, and/or any other device capable of controlling pressure within pressure chamber 12. In some examples, pressure control unit 14 includes a processor and non-transitory computer-readable media storing instructions for execution by the processor. Pressure control unit 14 may operate under the control of the processor based on instructions received from memory and/or user input to control the operation of system 10 and/or pressure therapy delivered using the device.

In some applications, system 10 is provided with a safety opening 40 configured to prevent pressure levels that may damage a patient by providing permanent communication, such as a permanent slow leak, to atmospheric pressure outside of the pressure chamber. The safety opening 40 may comprise a small hole or a valve configured to open under a particular pressure. While FIG. 4 shows the safety opening 40 incorporated into the pressure chamber 12, the safety opening 40 may be incorporated into the tubing 16 or the pressure control unit 14 in alternative embodiments. In each case the safety opening 40 safeguards against unintended high pressure levels and prolonged durations of pressure that may damage the post-stenotic region.

System 10 can provide many pressure-based treatments to a patient utilizing the device. In some applications, system 10 is used to generate pulsating or varying magnitude pressures inside of pressure chamber 12. Applying pulsating pressure to a localized part of the body (e.g., a limb) inserted into pressure chamber 12 may increase blood flow to skin, muscle, and/or other tissue. During application of the pulsating pressure, blood flow may be directly monitored by a monitoring device 42, such as an ultrasound blood pressure monitoring system, to ensure an increased flow that does not endanger the post-stenotic region. The pulsating pressure may include positive pressure pulses relative to ambient pressure (e.g., outside of the pressure chamber 12), negative pressure pulses relative to ambient pressure, or combinations of positive and negative pressure.

Some applications may involve application of asymmetric, predominantly negative, pulsating pressure to a part of the body inserted into pressure chamber 12. During application of negative pressure pulses, arteries, arterioles, arteriovenous anastomoses and/or capillaries in the portion of body subjected to the negative pressure pulses may dilate, increasing blood flow. Without wishing to be bound by any theory, it is believed that veins and venules may also dilate, with the dilatation of veins and venules sometimes being greater on the venous side than on the arterial side due to a lesser developed (thinner) muscular vessel wall. The greater dilatation on the venous side may create an increased arterio-venous pressure gradient over the capillaries (and the arteriovenous anastomoses if they are open). This may contribute to greater blood flow. However, if the veins are over-distended, a nervous spinal reflex called the veno-arterial reflex may induce constriction of arterioles to prevent venous over-distention. To help avoid this, the negative pressure creating venous distention may be intermittently applied.

In some examples, pressure control unit 14 of system 10 is configured to generate pressure pulses inside of pressure chamber 12 by alternatingly introducing a negative pressure to the pressure chamber during a negative pressure period and releasing the negative pressure from the pressure chamber during a release period. During the negative pressure period, pressure control unit 14 can withdraw air from inside of pressure chamber 12, generating a negative pressure relative to ambient pressure inside of the pressure chamber. During the release period, the negative pressure can be released and air allowed to flow back into pressure chamber 12, increasing the pressure inside of the pressure chamber. In some examples, a pressure inside of pressure chamber 12 is restored to approximately atmospheric pressure during the release period. In some additional examples, pressure control unit 14 pushes air into pressure chamber 12 during the release period, generating a positive pressure relative to ambient pressure inside of the pressure chamber during the release period.

When system 10 is used to apply pulsating pressures to a region of a patient in pressure chamber 12, any suitable duration of pressure pulses can be used. Alternately generated and released negative pressure normally comprises alternately generating negative pressure for a predetermined time interval and releasing the negative pressure for a predetermined time interval. In practice, alternatingly generating and releasing negative pressure within the pressure chamber 12 may involve alternatingly generating negative pressure for a time interval from about 1 to about 20 seconds, preferably about 5 to about 15 seconds, and releasing the negative pressure for a time interval ranging from about 2 to 15 seconds, preferably about 5 to about 10 seconds. Time intervals of increased length risk damaging the limb of a patient by holding blood stationary in the dilated vessels or straining the vessels and the post-stenotic region, while shorter intervals fail to generate the pressure gradient necessary to increase blood flow.

The duration of the negative pressure period may be the same as or different than the duration of the release period, however a duration of the negative pressure period longer than the duration of the release period is more efficient in moving blood, as arterial flow is often more impeded in a patient than venous flow. In one preferred method, alternatingly generating and releasing negative pressure within the pressure chamber 12 involves generating negative pressure for a time interval of about 10 seconds and releasing the negative pressure for a time interval of about 7 seconds.

Independent of the duration of the pressure pulses, any suitable pressure can be established inside of pressure chamber 12 during each negative pressure period and each release period. The pressure level inside of pressure chamber 12 during each negative pressure must be sufficient to create an increased arterio-venous pressure gradient over the capillaries (and the arteriovenous anastomoses if they are open) while not damaging the blood vessels, the post-stenotic region, or impeding the blood flow by causing pooling. A preferred negative pressure for this purpose is in the range of −20 mmHg to −100 mmHg, more preferably in the range of −40 to −80 mmHg, and most preferably in the range of −30 mmHg to −50 mmHg. The maximum pressure inside of pressure chamber 12 during each release period may be approximately atmospheric pressure or, in different examples, can be above or below atmospheric pressure.

For certain applications where a post-stenotic region is more durable, for example where a patient is younger and/or healthier and/or has recovered more from surgery, the pressure inside of pressure chamber 12 during each release period may be a positive pressure of corresponding but opposite magnitude as the pressure generated during the negative pressure period. Other positive pressures can be used during the release period. The positive pressure of the release period promotes increased blood flow across the arterio-venous pressure gradient and can help prevent pooling. Increasing the pressure inside of pressure chamber 12 during the release period promotes venous emptying, but must not involve a positive pressure that is too strong and could damage the blood vessels by constriction. While the pressure generated during a negative pressure pulse may range from −20 mmHg to −80 mmHg, the pressure inside of the pressure chamber during release may range from +80 mmHg to −10 mmHg, more preferably +20 mmHg to −40 mmHg, and most preferably +30 mmHg to −5 mmHg.

The following example explains post-surgical obstruction treatment recovery and rehabilitation therapy under the disclosure.

### Example

A 78 year old male patient was diagnosed with a stenosis within his superficial femoral artery. The patient underwent a surgical procedure in which a stent was inserted into his artery to reopen the blockage. Subsequently, the patient's leg was placed in a pressure chamber and exposed to alternating negative pressure therapy that involved generating pulses of negative pressure in the pressure chamber and then releasing the negative pressure pulses. The blood flow through the stent as reported in VolFlow, which represents the cross-sectional area of the artery multiplied by the time-averaged blood flow velocity, increased from 79 milliliters/minute to 134 milliliters/minute during application of negative pressure therapy.

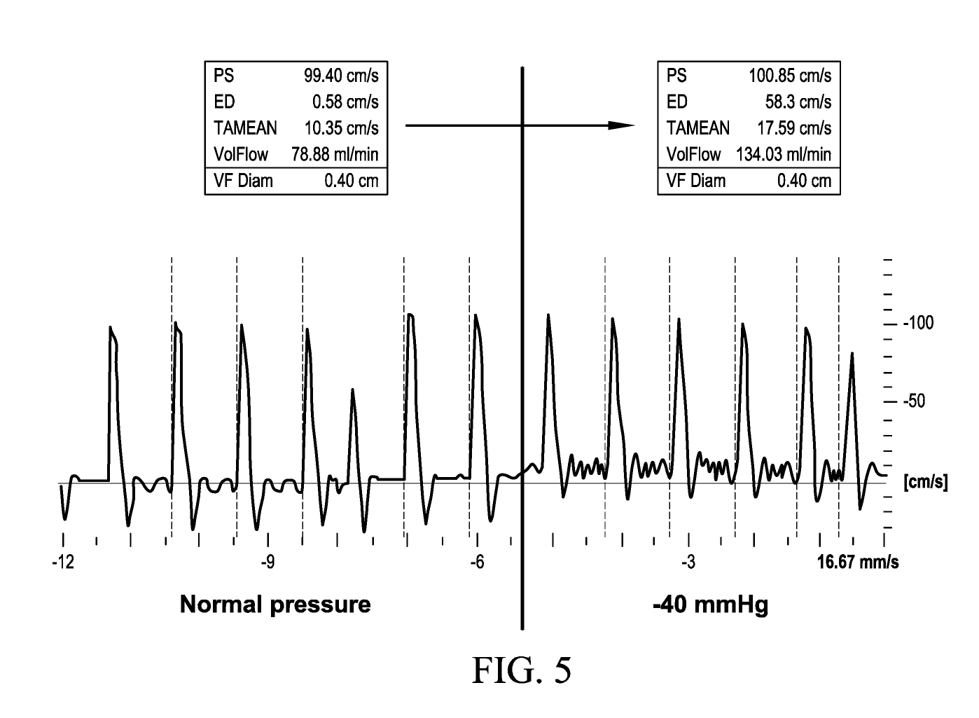

FIG. 5 is an image showing blood flow velocity through a stent in the superficial femoral artery during normal pressure (ambient pressure) and during application of negative pressure (−40 mm Hg). The units on the X-axis are seconds, and the units on the Y-axis are cm/s. The flow velocity was measured with a pulsed Doppler and average volume flow was calculated from six heart beats without pressure (from the time of about −10.5 to −5.5) and average volume flow from six heartbeats during negative pressure (from the time of about −5.5 to −1). As seen, the diastolic flow provided the functional increase in blood flow during application of negative pressure pulses.

In treatment of patients with negative pressure therapy, an average increase of 44-96% was observed in the blood flow of all patients under negative pressure compared to rest blood flow.

1. A method comprising:
enclosing a pressure chamber about at least a portion of a limb of a patient treated for an arterial obstruction;
sealing the portion of the limb from external conditions; and
alternately generating a negative pressure within the pressure chamber and releasing the negative pressure from within the pressure chamber using a pressure control unit, so as to increase volume and velocity of blood flowing past a region of an artery previously obstructed and increasing distal runoff.

2. The method of claim 1, wherein the step of alternately generating the negative pressure and releasing the negative pressure using the pressure control unit comprises alternately generating the negative pressure and releasing the negative pressure in the pressure chamber at least during a predetermined period after treatment for the arterial obstruction has been performed.

3. The method of claim 1, wherein applying the negative pressure and releasing the negative pressure comprises applying the negative pressure and releasing the negative pressure for a predetermined treatment session.

4. The method of claim 1, wherein the step of enclosing at least a portion of the limb comprises enclosing a portion of the limb on which treatment for the arterial obstruction was performed.

5. The method of claim 1, wherein the step of enclosing at least a portion of the limb comprises enclosing a portion of the limb distal from a portion on which treatment for the arterial obstruction was performed.

6. The method of claim 1, wherein the step of applying the negative pressure comprises applying the negative pressure for a first time interval and releasing the negative pressure comprises releasing the negative pressure for a second time interval, the first time interval being different than the second time interval.

7. The method of claim 6, wherein the first time interval is longer than the second time interval.

8. The method of claim 7, wherein the first time interval ranges from 10% to 25% longer than the second time interval.

9. The method of claim 7, wherein the first time interval and the second time interval each range from 5 seconds to 15 seconds.

10. The method of claim 1, wherein applying the negative pressure comprises generating a negative pressure inside of the pressure chamber ranging from −20 mm Hg (−2.7 KPa) to −80 mm Hg (−10.7 KPa), and releasing the negative pressure comprises increasing the pressure inside the pressure chamber to a range from +80 mm Hg (+10.7 KPa) to −10 mm Hg (−1.3 KPa).

11. The method of claim 1, wherein the pressure chamber has a seal and is configured to receive at least a foot of the patient, and enclosing the portion of the limb comprises inserting at least the foot of the patient inside the pressure chamber and sealing the pressure chamber against a leg of the patient with the seal.

12. The method of claim 1, wherein a limb support structure is positioned inside of the pressure chamber, the limb support structure having an elongated body extending from a distal end located inside of the pressure chamber toward a closed distal end of the pressure chamber and a proximal end located toward an open proximal end of the pressure chamber.

13. The method of claim 12, wherein the limb support structure is offset at the distal end of the elongated body relative to an adjacent portion of the elongated body, thereby forming a pocket into which a distal portion of the limb of the patient can be inserted and exposed to pressure therapy around a circumference of the distal portion of the limb.

14. The method of claim 12, wherein the limb support structure is removably securable to the pressure chamber, such that the limb may be secured in the pressure chamber in a plurality of configurations.

15. The method of claim 12, wherein the limb support structure is secured to the pressure chamber such that an uppermost region of the limb support structure extends beyond the pressure chamber.

16. The method of claim 12, wherein the limb support structure is configured with an opening to prevent contacting a post-stenotic region of the limb.

17. A method of treating a patient having an obstruction within a vascular structure of a limb, wherein the obstruction is opened or bypassed, the method comprising:
introducing at least a portion of the limb into a pressure chamber such that the portion of the limb is sealed from external conditions; and
alternatingly generating negative pressure pulses within the pressure chamber and releasing negative pressure from the pressure chamber.
